(19) United States
(12) Patent Application Publication
(10) Pub. No.: US 2022/0102090 A1
(43) Pub. Date: Mar. 31, 2022

(54) MOVABLE MEMBER AND INPUT DEVICE

(71) Applicant: Panasonic Intellectual Property Management Co., Ltd., Osaka (JP)

(72) Inventor: RYOSUKE NAKAO, Okayama (JP)

(21) Appl. No.: 17/420,701

(22) PCT Filed: Jan. 15, 2020
(86) PCT No.: PCT/JP2020/000980

§ 371 Date: Jul. 5, 2021

(30) Foreign Application Priority Data
Jan. 23, 2019 (JP) 2019-009547

(51) Int. Cl. H01H 13/14; H01H 13/20

(52) U.S. Cl. CPC H01H 13/14; H01H 13/20

(57) ABSTRACT

A movable member includes an elastically deformable portion that curves upward in a protruding manner and includes a movable electrode, and a support portion having a leg portion extending downward from a peripheral edge of the elastically deformable portion, an extension portion extending upward from the leg portion, and a connecting portion connecting the leg portion and the extension portion. The leg portion has an intermediate portion positioned between both end portions in a width direction of the leg portion, the intermediate portion protruding, a boundary between the leg portion and the extension portion has an arc shape in top view, and a lower surface of the connecting portion is a protruding curved surface protruding downward.

### TECHNICAL FIELD

The present disclosure generally relates to a movable member and an input device, and particularly relates to a movable member and an input device used for input to various electronic devices.

### BACKGROUND ART

PTL 1 discloses a push-on switch. The push-on switch of PTL 1 includes a box-shaped case made of an insulating resin having a recess open to the upper side. An inner bottom surface of the recess of the case is formed as a contact arrangement portion in which a central portion is further recessed in a circular shape. An outer fixed contact is disposed at an outer peripheral position of a bottom portion of the contact arrangement portion, and a central fixed contact is disposed at a central position of the outer fixed contact, the outer fixed contact and the central fixed contact electrically independent from each other. Additionally, the push-on switch includes a movable contact made of a highly conductive metal thin plate formed in an upward convex dome shape, and a lower end of an outer peripheral portion of the dome shape is placed on the outer fixed contact in the contact arrangement portion.

### CITATION LIST

### Patent Literature

PTL 1: Unexamined Japanese Patent Publication No. 2006-120397

### SUMMARY OF THE INVENTION

When the push-on switch is operated, the lower end of the outer peripheral portion of the movable contact slides on the outer fixed contact. As a result, the outer fixed contact is scraped, and scrape dust is generated. Such scrape dust may contribute to a decrease in reliability (particularly long-term reliability) of the push-on switch (input device).

An object of the present disclosure is to provide a movable member and an input device that can improve reliability.

A movable member according to one aspect of the present disclosure includes an elastically deformable portion that curves upward in a protruding manner and includes a movable electrode, and a support portion having a leg portion extending downward from a peripheral edge of the elastically deformable portion, an extension portion extending upward from the leg portion, and a connecting portion connecting the leg portion and the extension portion. The leg portion has an intermediate portion positioned between both end portions in a width direction of the leg portion, the intermediate portion protruding, a boundary between the leg portion and the extension portion has an arc shape in top view, and a lower surface of the connecting portion is a protruding curved surface protruding downward.

An input device according to one aspect of the present disclosure includes: a fixed electrode; a base having a mounting surface on which the fixed electrode is provided; and the movable member described above. The movable member is mounted on the mounting surface, the movable electrode facing the fixed electrode, and the protruding curved surface of the movable member is in contact with the mounting surface.

The present disclosure has an effect of improving reliability.

### BRIEF DESCRIPTION OF DRAWINGS

FIG. 1A is a schematic cross-sectional view of an input device of a first exemplary embodiment in a first state.

FIG. 1B is a partial view of a portion indicated by P in FIG. 1A.

FIG. 2 is a schematic cross-sectional view of the input device of the first exemplary embodiment in a second state.

FIG. 3 is a perspective view of the input device of the first exemplary embodiment.

FIG. 4 is an exploded perspective view of the input device of the first exemplary embodiment.

FIG. 5 is a plan view of a case of the input device of the first exemplary embodiment.

FIG. 6 is a perspective view of a movable member of the input device of the first exemplary embodiment.

FIG. 7 is another perspective view of the movable member of the input device of the first exemplary embodiment.

FIG. 8 is a plan view of the movable member of the input device.

FIG. 9 is a bottom view of the movable member of the input device.

FIG. 10A is a cross-sectional view taken along line A-A of FIGS. 8 and 9.

FIG. 10B is a cross-sectional view taken along line B-B of FIGS. 8 and 9.

FIG. 11A is an explanatory diagram of a method of manufacturing the movable member of the input device.

FIG. 11B is an explanatory diagram of the method of manufacturing the movable member of the input device.

FIG. 11C is an explanatory diagram of the method of manufacturing the movable member of the input device.

FIG. 12 is an explanatory diagram of the input device of the first exemplary embodiment.

FIG. 13 is an explanatory diagram of an input device of Comparative Example 1.

FIG. 14 is an explanatory diagram of an input device of Comparative Example 2.

FIG. 15 is a diagram showing a test result of the input device of the first exemplary embodiment.

FIG. 16 is a diagram showing a test result of the input device of Comparative Example 1.

FIG. 17 is a diagram showing a test result of the input device of Comparative Example 2.

FIG. 18 is a perspective view of an input device of a second exemplary embodiment.

FIG. 19 is an exploded perspective view of the input device of the second exemplary embodiment.

FIG. 20 is a perspective view of a movable member of an input device of Modification 1.

FIG. 21 is a perspective view of a movable member of an input device of Modification 2.

### DESCRIPTION OF EMBODIMENTS

### 1. Exemplary Embodiment

### 1.1 First Exemplary Embodiment

### 1.1.1 Outline

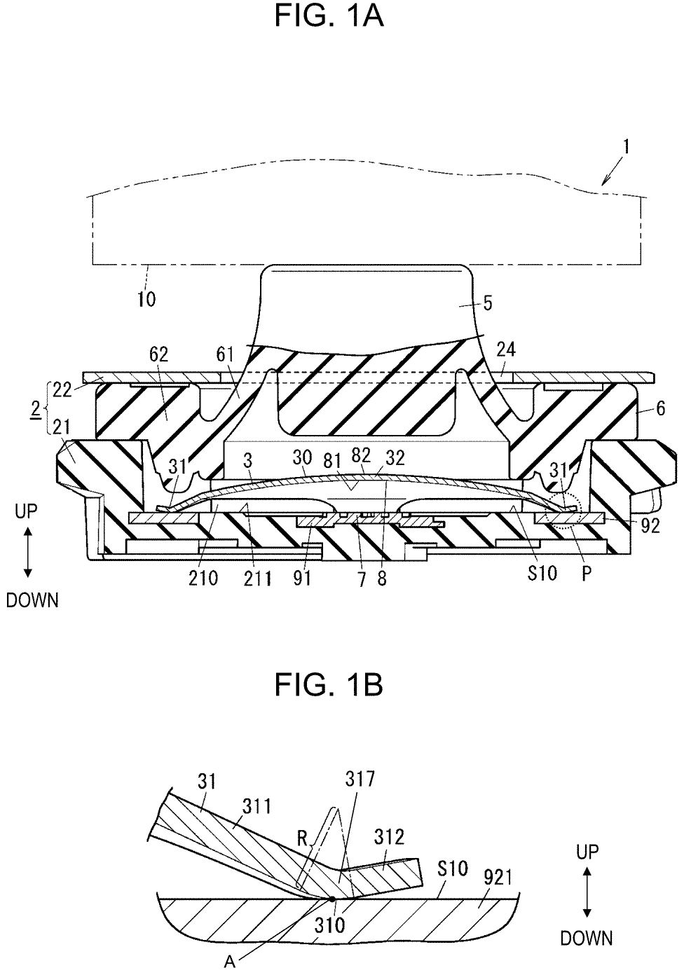

FIG. 1A shows a schematic cross-sectional view of input device 1 of one exemplary embodiment of the present disclosure. Input device 1 includes movable member 3. As shown in FIGS. 6 to 9, movable member 3 includes elastically deformable portion 30 and support portion 31. Elastically deformable portion 30 includes movable electrode 8 having first surface 81 and second surface 82. Support portion 31 has leg portion 311 protruding from the peripheral edge of elastically deformable portion 30 in a first direction that first surface 81 faces, and extension portion 312 protruding from the tip end of leg portion 311 in a second direction opposite to the first direction. As shown in FIG. 10A, in leg portion 311, intermediate portion 311b between both end portions 311a protrudes more than both end portions 311a in the width direction of leg portion 311. As shown in FIG. 8, the boundary between leg portion 311 and extension portion 312 has an arc shape in top view. As shown in FIG. 1B, the boundary portion has protruding curved surface 310 facing the first direction. A portion connecting leg portion 311 and extension portion 312 may be referred to as “connecting portion 317” for easy description. A lower surface of connecting portion 317 is protruding curved surface 310.

Note that in the present disclosure, the description will be given using terms indicating directions such as “up”, “down”, “left”, “right”, “upper”, and “lower”. However, these terms merely indicate a relative positional relationship, and the present disclosure is not limited thereto.

Input device 1 further includes base 21. Base 21 has mounting surface S10 on which fixed electrode 7 is provided. Movable member 3 has movable electrode 8 facing fixed electrode 7, and support portion 31 supported by mounting surface S10. Movable member 3 is deformable such that movable electrode 8 approaches fixed electrode 7. Support portion 31 has protruding curved surface 310, and is in contact with mounting surface S10 at protruding curved surface 310. That is, movable member 3 is mounted on mounting surface S10 at protruding curved surface 310 such that movable electrode 8 faces fixed electrode 7.

In input device 1, movable member 3 is in contact with mounting surface S10 at protruding curved surface 310 of support portion 31. Hence, generation of scrape dust caused by sliding of movable member 3 on mounting surface S10 can be reduced. Further, since support portion 31 has protruding curved surface 310, scrape dust can be brushed off, and accumulation of scrape dust between protruding curved surface 310 and mounting surface S10 can be curbed. Accordingly, it is possible to curb a decrease in reliability (particularly long-term reliability) due to generation of scrape dust. As described above, according to movable member 3 and input device 1, reliability can be improved.

### 1.1.2 Details

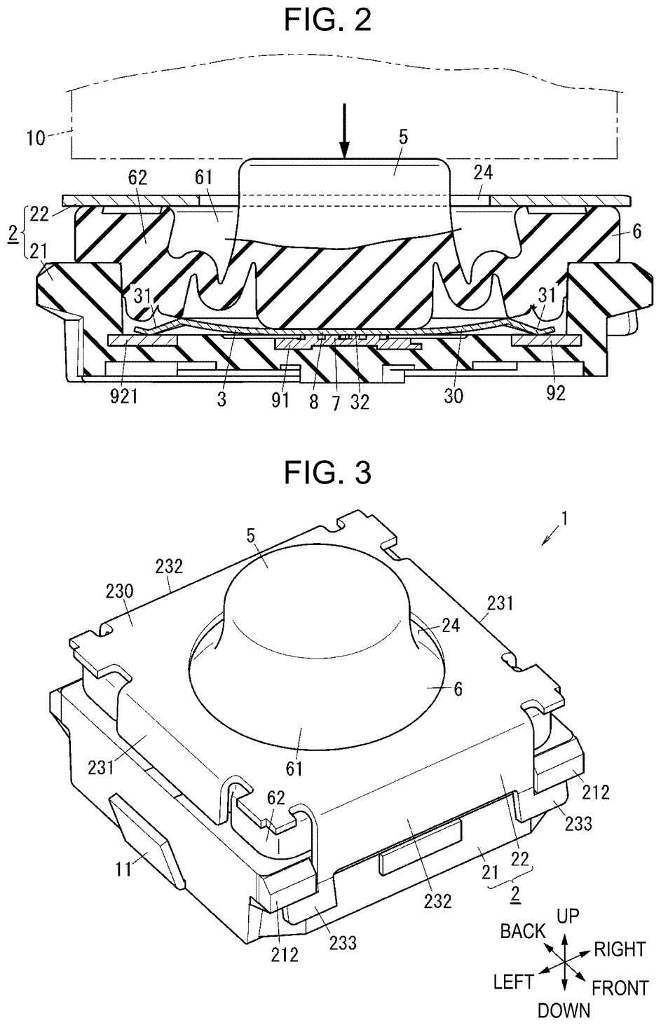

Movable member 3 and input device 1 will be described in more detail below. FIG. 3 is a perspective view of input device 1. Input device 1 is a so-called push switch. Input device 1 is used for input to various electronic devices such as a personal digital assistant, an in-vehicle device, and a home appliance. For example, input device 1 mounted on a printed circuit board is built in a housing of the device. In this case, for example, operation button 10 (see FIGS. 1A and 2) is disposed as an intermediate member at a position corresponding to input device 1 in the housing. With this configuration, when the operator presses operation button 10, input device 1 is indirectly operated through operation button 10.

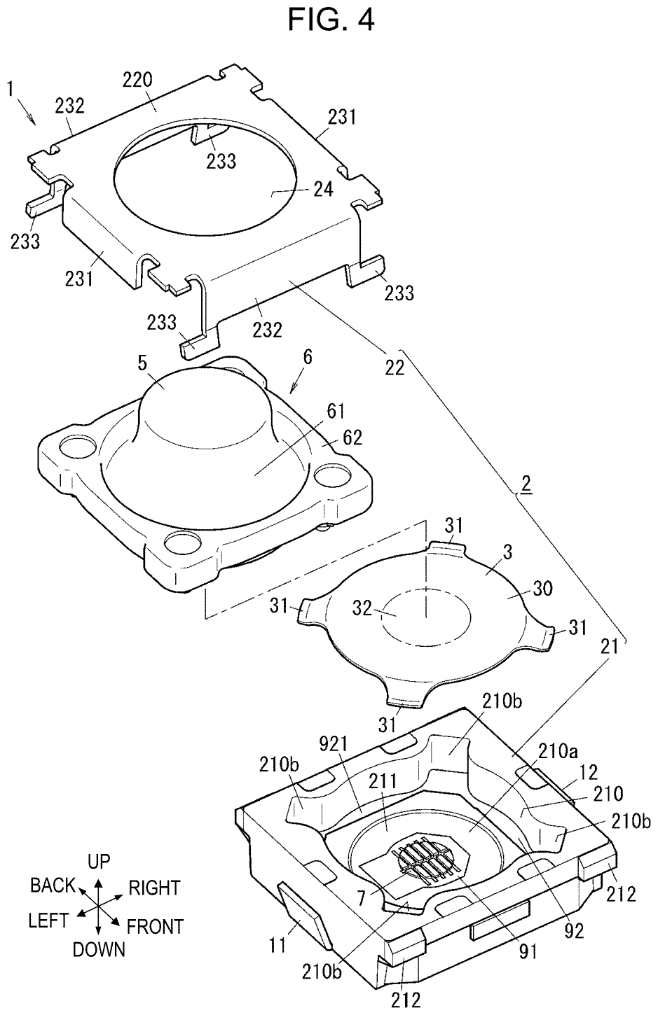

As shown in FIG. 4, input device 1 includes case 2, movable member 3, pusher 5, holder 6, and conductive members (first and second conductive members) 91, 92.

As shown in FIGS. 3 and 4, case 2 accommodates movable member 3, pusher 5, holder 6, and conductive members 91, 92. Case 2 includes base (body) 21 and cover 22.

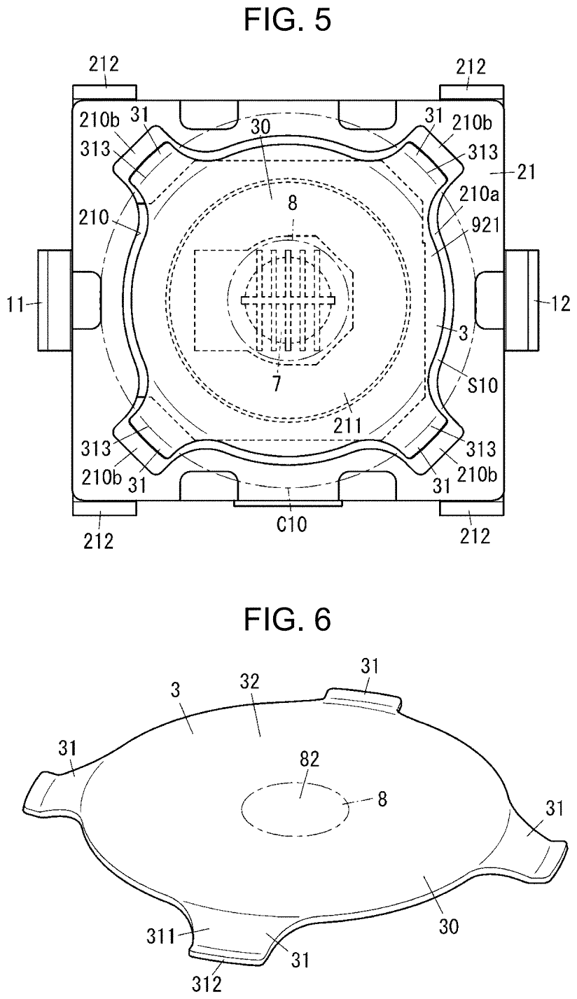

As shown in FIGS. 4 and 5, base 21 has a flat quadrangular (e.g., square) box shape. Base 21 has electrical insulation. As one example, base 21 is made of synthetic resin. Base 21 has recess 210 on one surface (upper surface in FIG. 4) in the thickness direction. Recess 210 forms a space for accommodating movable member 3. Bottom surface 211 of recess 210 forms a part of mounting surface S10 for mounting movable member 3. As shown in FIG. 5, recess 210 has first space 210a having a circular shape in plan view, and multiple (four in present exemplary embodiment) second spaces 210b protruding outward from first space 210a. Four second spaces 210b are arranged at equal intervals in the circumferential direction of first space 210a. Additionally, base 21 has a pair of protrusions 212 on both side surfaces (front side surface and rear side surface). The pair of protrusions 212 are separated in the right-left direction.

As shown in FIG. 4, cover 22 is attached to base 21 so as to partially cover recess 210 of base 21. Cover 22 is made of metal. Cover 22 has flat plate portion 220. Flat plate portion 220 has a quadrangular shape (e.g., square) in plan view. Two first projections 231 and two second projections 232 protruding downward are provided on four sides of flat plate portion 220. Two first projections 231 and two second projections 232 have a rectangular plate shape. Two first projections 231 face each other at an interval in the right-left direction, and two second projections 232 face each other at an interval in the front-rear direction. Two first projections 231 and two second projections 232 are brought into contact with holder 6 to position holder 6 with respect to case 2 in plan view. Each of two second projections 232 faces the other at an interval in the front-rear direction, and has a pair of hooking claws 233 protruding from the tip end. The pair of hooking claws 233 are separated from each other. By hooking the pair of hooking claws 233 of two second projections 232 on the pair of protrusions 212 of base 21, base 21 and cover 22 are coupled to each other. Additionally, through hole 24 is provided in a central portion of flat plate portion 220 of cover 22. Through hole 24 is a hole for exposing pusher 5. Through hole 24 has a circular shape in plan view.

Each of first conductive member 91 and second conductive member 92 is made of a conductive material (metal plate in present exemplary embodiment). First conductive member 91 and second conductive member 92 are attached to base 21 so as not to contact each other. In particular, in the present exemplary embodiment, first conductive member 91 and second conductive member 92 are integrated with base 21 by insert molding. That is, base 21 is insert-molded using first conductive member 91 and second conductive member 92 as inserted objects.

As shown in FIG. 4, first conductive member 91 has electrode (fixed electrode) 7 and a terminal (first terminal 11). First conductive member 91 has a portion exposed at the center of bottom surface 211 of recess 210 of base 21, and fixed electrode 7 is provided in this portion. As described above, fixed electrode 7 is provided so as to be exposed on mounting surface S10. Fixed electrode 7 has a circular shape in plan view. First terminal 11 protrudes outward from the side surface of base 21. For example, first terminal 11 can be mechanically coupled and electrically connected, by soldering, to a conductive member on the printed circuit board on which input device 1 is mounted.

As shown in FIG. 4, second conductive member 92 has an electrode (supporting electrode 921) and a terminal (second terminal 12). Supporting electrode 921 has a frame shape. Supporting electrode 921 is exposed on bottom surface 211 of recess 210. In particular, supporting electrode 921 is exposed on a peripheral portion of bottom surface 211 avoiding fixed electrode 7 at the central portion of bottom surface 211 of recess 210. At least supporting electrode 921 is exposed at a position corresponding to each of second spaces 210b of recess 210. The surface of supporting electrode 921 is flush with bottom surface 211, and forms mounting surface S10 together with bottom surface 211. Second terminal 12 protrudes outward from a side surface of base 21. In particular, second terminal 12 protrudes from a side surface of base 21 opposite to first terminal 11. For example, second terminal 12 can be mechanically coupled and electrically connected, by soldering, to the conductive member on the printed circuit board on which input device 1 is mounted.

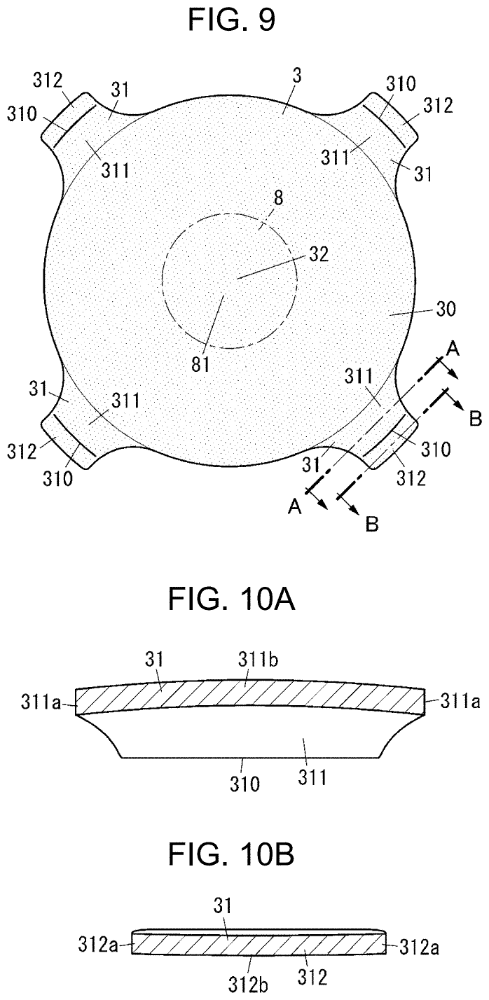

Hereinafter, movable member 3 will be described with reference to FIGS. 4 to 9, FIGS. 10A and 10B, and FIGS. 11A to 11C. As shown in FIGS. 4 to 9, movable member 3 has a circular plate shape as a whole. Note that FIG. 8 is a plan view of movable member 3, and FIG. 9 is a bottom view of movable member 3. Since FIGS. 8 and 9 have similar appearances, dotted hatching is applied to FIG. 9 in order to distinguish them.

Movable member 3 has elastically deformable portion 30 and support portion (multiple support portions in present exemplary embodiment) 31. Movable member 3 has conductivity. In the present exemplary embodiment, movable member 3 is formed of an elastic material, and elastically deformable portion 30 and support portion 31 are integrated. Examples of the elastic material include a metal plate. As one example, a metal plate made of stainless steel (SUS 301) having a thickness of 0.075 mm can be used as the material of movable member 3. Note that the metal plate may be coated with a film (e.g., plating film) of metal (gold or silver) having higher conductivity than the material of the metal plate (e.g., stainless steel) as necessary.

Elastically deformable portion 30 has a dome shape. In particular, elastically deformable portion 30 has a circular shape in plan view. Elastically deformable portion 30 is a so-called metal dome. One surface (upper surface in FIG. 4) of elastically deformable portion 30 in the thickness direction is a convex surface, and a central portion thereof forms pressure receiving portion 32. When pressure receiving portion 32 of elastically deformable portion 30 is pressed, elastically deformable portion 30 is elastically deformed as shown in FIG. 2, whereby a click feeling is generated. More specifically, due to this elastic deformation, a central portion of elastically deformable portion 30 flips from the convex state to a concave state. As described above, when pressure receiving portion 32 is pressed, elastically deformable portion 30 elastically deforms such that pressure receiving portion 32 is recessed, and generates a click feeling. In the present exemplary embodiment, a portion corresponding to the central portion (pressure receiving portion 32) of elastically deformable portion 30 forms movable electrode 8. As shown in FIG. 1A and FIGS. 6 to 9, movable electrode 8 has first surface 81 and second surface 82. First surface 81 is a surface of movable electrode 8 facing fixed electrode 7 (surface facing mounting surface S10), and second surface 82 is a surface opposite to first surface 81. In the present exemplary embodiment, first surface 81 is a concave surface, and second surface 82 is a convex surface. Movable electrode 8 is a central portion of elastically deformable portion 30. Accordingly, elastically deformable portion 30 is deformable such that movable electrode 8 moves in the first direction that first surface 81 faces by pressing of second surface 82 of movable electrode 8. The direction that first surface 81 faces is considered with respect to the reference point of first surface 81. In the present exemplary embodiment, the reference point of first surface 81 is the center of first surface 81, and is the most recessed portion. Here, it can also be said that the first direction is a direction headed toward fixed electrode 7 from movable electrode 8. Here, the first direction is downward. Additionally, the second direction is upward.

The multiple (four in present exemplary embodiment) support portions 31 are portions of movable member 3 supported by mounting surface S10. Each support portion 31 protrudes from the peripheral edge of elastically deformable portion 30. As shown in FIG. 5, four support portions 31 radially extend from elastically deformable portion 30 (movable electrode 8) in plan view. Four support portions 31 are arranged at equal intervals in the circumferential direction of elastically deformable portion 30. As described above, support portions 31 are disposed so as to surround elastically deformable portion 30.

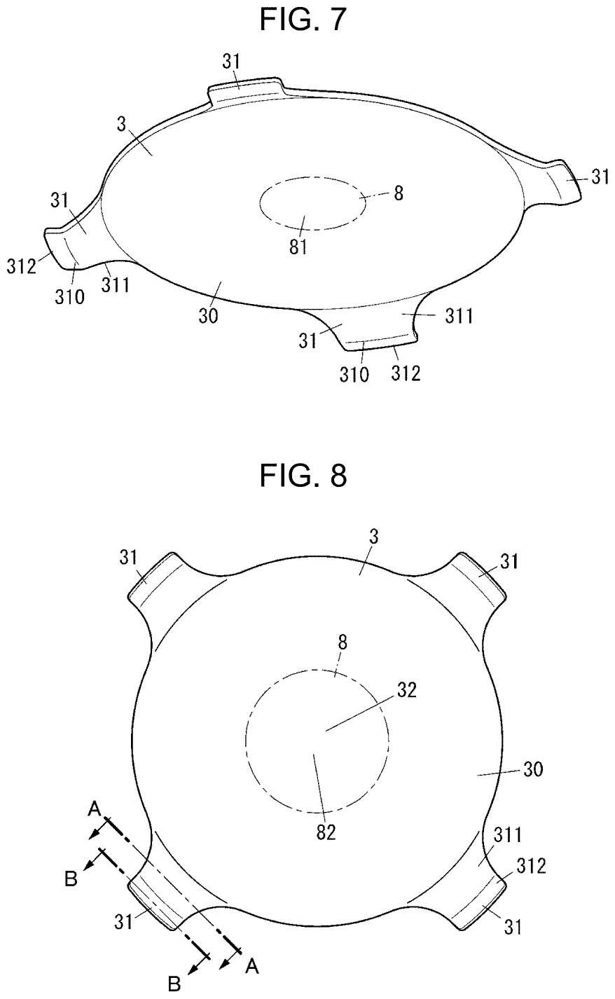

As shown in FIGS. 6 to 9, each support portion 31 has a plate shape, and has a width narrowing toward the tip end. Further, each support portion 31 includes leg portion 311 and extension portion 312. As shown in FIGS. 1A and 1B, leg portion 311 extends from the peripheral edge of elastically deformable portion 30 toward mounting surface S10. In other words, as shown in FIG. 7, leg portion 311 protrudes in the first direction (direction that first surface 81 of movable electrode 8 faces). Here, “leg portion 311 protrudes in first direction” includes that leg portion 311 protrudes not only in the same direction as the first direction but also in a direction at an angle less than 90 degrees with respect to the first direction. In short, if the vector in the direction in which leg portion 311 protrudes includes a component in the same direction as the first direction, it can be said that “leg portion 311 protrudes in the first direction”. As shown in FIGS. 1A and 1B, extension portion 312 extends from the tip end of leg portion 311 in a direction separating from mounting surface S10. Hence, input device 1 includes, at the tip end of leg portion 311, extension portion 312 extending in a direction separating from mounting surface S10. In other words, as shown in FIG. 8, extension portion 312 protrudes from the tip end of leg portion 311 in the second direction opposite to the first direction. Here, “extension portion 312 protrudes in the second direction” includes that extension portion 312 protrudes not only in the same direction as the second direction but also in a direction at an angle less than 90 degrees with respect to the second direction. In short, if the vector in the direction in which extension portion 312 protrudes includes a component in the same direction as the second direction, it can be said that “extension portion 312 protrudes in the second direction”. As described above, input device 1 includes, at the tip end of leg portion 311, extension portion 312 extending in the direction separating from mounting surface S10.

In other words, leg portion 311 extends downward from the peripheral edge of elastically deformable portion 30, and extension portion 312 extends upward from leg portion 311.

Then, as shown in FIG. 1B, support portion 31 has an L shape in side view. In support portion 31, the lower surface of connecting portion 317 between leg portion 311 and extension portion 312 is protruding curved surface 310. Support portion 31 is in contact with mounting surface S10 at protruding curved surface 310. Note that in the case of providing protruding curved surface 310 in contact with mounting surface S10, it is desirable to form protruding curved surface 310 with one bent line. However, two or more bent lines may be provided at close positions to form multiple protruding curved surfaces. In this case, a protruding curved surface corresponding to one of the two or more bent lines may serve as protruding curved surface 310 in contact with mounting surface S10.

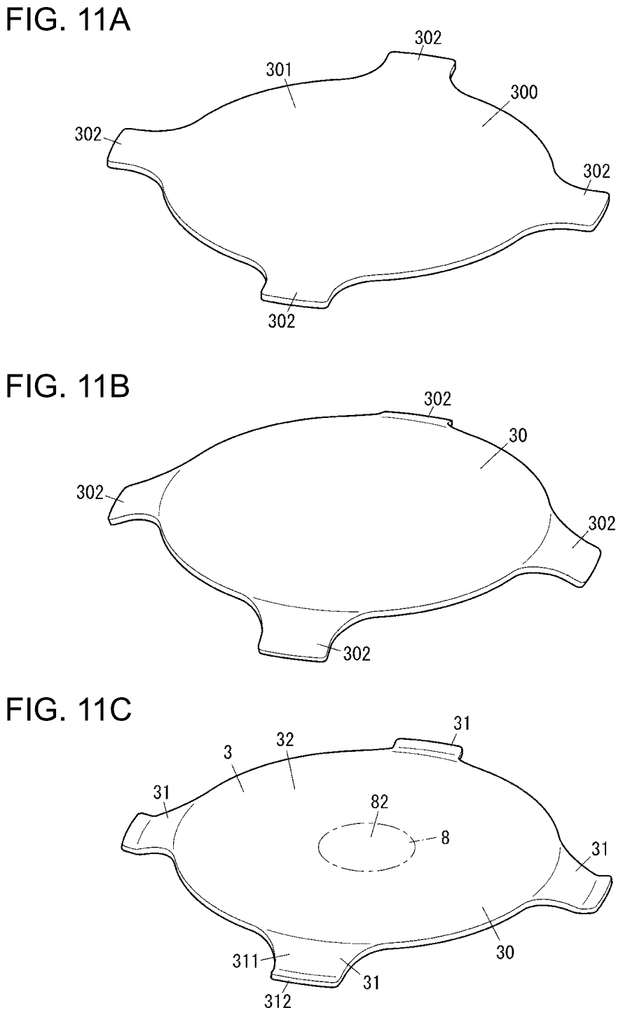

Movable member 3 can be formed by punching and bending a metal plate. The method of manufacturing movable member 3 may include, for example, a punching step, a first bending step, and a second bending step. In the punching step, as shown in FIG. 11A, portion 300 used as movable member 3 is formed by punching a metal body. Portion 300 includes first portion 301 to be elastically deformable portion 30 and multiple (four) second portions 302 to be support portions 31. First portion 301 has a circular shape. Second portion 302 protrudes from the peripheral edge of first portion 301. The protruding direction of second portion 302 is along the radial direction of first portion 301. In the first bending step, as shown in FIG. 11B, first portion 301 is bent as a whole to form elastically deformable portion 30. Here, portion 300 is bent in a spherical shape as a whole. Further, second portion 302 is bent with respect to first portion 301. The degree of bending is determined by the angle between elastically deformable portion 30 and leg portion 311 of support portion 31. Note that second portion 302 does not need to be bent with respect to first portion 301 depending on the angle between elastically deformable portion 30 and leg portion 311 of support portion 31. In the second bending step, as shown in FIG. 11C, second portion 302 to be support portion 31 is bent. Here, a tip end portion of the second portion is bent along curve 313 (see FIG. 5) instead of a straight line. This curve is an arc. The center of the arc coincides with the center of elastically deformable portion 30.

As described above, support portion 31 (leg portion 311 and extension portion 312) is formed by bending the tip end portion of the metal plate (second portion 302) to be support portion 31. Accordingly, protruding curved surface 310 is formed by the bending for forming extension portion 312. In the present exemplary embodiment, radius of curvature R (see FIG. 1B) of protruding curved surface 310 is 0.2 mm. Note that radius of curvature R is preferably 0.15 mm or more. On the other hand, radius of curvature R is preferably 0.25 mm or less.

Further, in the present exemplary embodiment, the tip end portion of the metal plate (second portion 302) to be support portion 31 is bent along curve 313 (see FIG. 5) instead of a straight line. Hence, as shown in FIGS. 5 to 7, the lower surface of the boundary portion (connecting portion 317) between leg portion 311 and extension portion 312 has an arc shape. Hence, a contact portion of protruding curved surface 310 with mounting surface S10 has an arc shape. In other words, protruding curved surface 310 can be brought into linear contact with mounting surface S10. This improves physical stability and electrical stability. For example, in the case where leg portion 311 has a shape curved upward in the width direction as in the present exemplary embodiment, if the boundary portion is bent along a straight line in plan view instead of curve 313, a difference in height position may occur between both ends in the width direction and the intermediate portion. At the boundary portion of this configuration, the movable member comes into point contact with mounting surface S10, the contact limited to both end portions in the width direction. This configuration causes wobbling in a state where the movable member is placed on mounting surface S10. Additionally, since the boundary portion comes into point contact with mounting surface S10, it is difficult to obtain electrical stability. On the other hand, by providing the boundary portion bent along curve 313 according to the present exemplary embodiment, protruding curved surface 310 comes into linear contact with mounting surface S10, and the physical characteristics and the electrical characteristics are stabilized. In particular, as shown in FIG. 5, a contact portion of protruding curved surface 310 with mounting surface S10 (boundary portion between leg portion 311 and extension portion 312) extends in an arc shape centered on movable electrode 8 (elastically deformable portion 30) in plan view. Hence, the contact portion of protruding curved surface 310 with mounting surface S10 is on circle C10 centered on movable electrode 8 (elastically deformable portion 30). With this setting, protruding curved surface 310 and mounting surface S10 are brought into linear and uniform contact, so that the contact therebetween is improved. Accordingly, support portion 31 of movable member 3 can slides on mounting surface S10 more easily. Additionally, the outer periphery of elastically deformable portion 30 extends in a circular shape centered on movable electrode 8 in plan view. Hence, circle C10 is concentric with the outer periphery of elastically deformable portion 30. In the present exemplary embodiment, the diameter of the outer periphery of elastically deformable portion 30 is 4.5 mm, and the diameter of the circumscribed circle of movable member 3 (circle abutting on tip end of extension portion 312 of movable member 3) is 5.8 mm. In this case, the diameter of circle C10 ranges from 4.8 to 5.6 mm, and is 5.4 mm, for example. In other words, the radius of curvature of the boundary portion between leg portion 311 and extension portion 312 ranges from 2.4 to 2.8 mm, and is 2.7 mm, for example.

Further, as shown in FIG. 10A, leg portion 311 has both end portions 311a in the width direction and intermediate portion 311b between both end portions 311a, and intermediate portion 311b protrudes upward from both end portions 311a. In the present exemplary embodiment, leg portion 311 is curved in the width direction of leg portion 311 such that intermediate portion 311b protrudes upward from both end portions 311a. Additionally, intermediate portion 311b of leg portion 311 protrudes most at the center of intermediate portion 311b (center of leg portion 311). The radius of curvature of the surface of leg portion 311 in a cross section orthogonal to the length direction of leg portion 311 (direction in which leg portion 311 protrudes) can be appropriately set by the operating force (pressing force, click rate) of movable member 3. As an example, when movable member 3 is made of stainless steel (SUS 301) having a thickness of 0.075 mm, the pressing force is 2.2 N, and the click rate is 55%, the radius of curvature may be 6.0 mm to 8.0 mm, and may be 6.9 mm, for example. Additionally, the center in the width direction of leg portion 311 protrudes in the second direction. This is because leg portion 311 extends from the peripheral edge of elastically deformable portion 30 having a dome shape. Note that the width direction of leg portion 311 is a direction orthogonal to both the direction in which leg portion 311 protrudes (i.e., length direction) and the thickness direction of leg portion 311.

Further, as shown in FIG. 10B, extension portion 312 has both end portions 312a in the width direction and intermediate portion 312b between both end portions 312a, and intermediate portion 312b protrudes downward from both end portions 312a. In the present exemplary embodiment, extension portion 312 is curved in the width direction of extension portion 312 such that intermediate portion 312b protrudes downward from both end portions 312a. Additionally, intermediate portion 312b of extension portion 312 protrudes most at the center of intermediate portion 312b (center of extension portion 312). Additionally, the center in the width direction of extension portion 312 protrudes in the first direction. That is, the center in the width direction of leg portion 311 and the center in the width direction of extension portion 312 extend in opposite directions. This is because extension portion 312 is formed by bending a tip end portion of the metal plate serving as support portion 31 not along a straight line but along curve 313 (see FIG. 5). Note that the width direction of extension portion 312 is a direction orthogonal to both the direction in which extension portion 312 protrudes (i.e., length direction) and the thickness direction of extension portion 312.

In the present exemplary embodiment, as shown in FIG. 1B, the lower end of the lower surface (protruding curved surface 310) of connecting portion 317 is an arc-shaped line. The line is shown as point Ain FIG. 1B. Although the line is shown as point A because FIG. 1B is a cross-sectional view, the line is actually a line extending from the near side to the far side in FIG. 1B, and the line draws an arc when viewed from below. Additionally, the height in the up-down direction of the arc-shaped line is constant. For example, referring to FIG. 7, the arc-shaped line extends substantially along the line indicated by protruding curved surface 310 in FIG. 7.

That is, the lower end of the lower surface (protruding curved surface 310) of connecting portion 317 is an arc-shaped line having a constant height position.

As shown in FIG. 5, movable member 3 is accommodated in recess 210 of base 21 and placed on mounting surface S10. In particular, four support portions 31 are mounted on supporting electrode 921 of second conductive member 92 so as to be positioned in four second spaces 210b of recess 210, respectively. As a result, movable electrode 8 of elastically deformable portion 30 is held at a position facing fixed electrode 7 of case 2. Since elastically deformable portion 30 is elastically deformable, movable member 3 is deformable (elastically) such that movable electrode 8 approaches fixed electrode 7 (see FIGS. 1A and 2).

Pusher 5 is a member for pressing pressure receiving portion 32 of elastically deformable portion 30 of movable member 3. Pusher 5 has electrical insulation. Pusher 5 is made of an elastic material (rubber in present exemplary embodiment). Pusher 5 has a solid columnar shape. Pusher 5 is disposed on the opposite side of fixed electrode 7 with respect to movable member 3, so that pusher 5 faces pressure receiving portion 32 of movable member 3. In the present exemplary embodiment, in a normal state, pusher 5 and movable member 3 are not in contact with each other and there is a gap between pusher 5 and pressure receiving portion 32 of movable member 3.

Holder 6 is a member for attaching pusher 5 to case 2. Holder 6 has electrical insulation. Holder 6 is made of an elastic material (rubber in present exemplary embodiment). As shown in FIG. 4, holder 6 includes main portion 61 and base portion 62. As shown in FIG. 1A, main portion 61 has a hollow truncated cone shape. Main portion 61 is integrally connected to an intermediate portion of a side surface of pusher 5 at an opening end (upper opening end in FIG. 1A) on a side far from base 21. That is, in the present exemplary embodiment, pusher 5 and holder 6 are integrally formed. Base portion 62 has a rectangular frame shape having a circular opening. Main portion 61 is integrally connected to an inner side surface of base portion 62 at an opening end (lower opening end in FIG. 1A) on a side close to base 21. Base portion 62 is sandwiched between base 21 and cover 22 and fixed to case 2.

### 1.1.3 Operation

Hereinafter, an operation of input device 1 will be described. Input device 1 has a first state shown in FIG. 1A and a second state shown in FIG. 2. In the first state, elastically deformable portion 30 of movable member 3 is not elastically deformed, and movable electrode 8 is not in contact with fixed electrode 7. Hence, in the first state, first terminal 11 and second terminal 12 are not electrically connected to each other. In the second state, elastically deformable portion 30 of movable member 3 is elastically deformed, and movable electrode 8 is in contact with fixed electrode 7. Hence, in the second state, first terminal 11 and second terminal 12 are electrically connected to each other. Hence, it can be said that the first state and the second state are an off state and an on state, respectively.

In order to change input device 1 from the first state to the second state, the operator only needs to press pusher 5 with a certain force or more.

As a result, pressure receiving portion 32 of movable member 3 is pressed toward mounting surface S10 through pusher 5. As a result, elastically deformable portion 30 of movable member 3 is gradually deformed. Then, when the magnitude of the force pressing elastically deformable portion 30 exceeds a certain value, elastically deformable portion 30 is vigorously buckled and greatly deformed (see FIG. 2). With such a flipping operation of elastically deformable portion 30, the operator pressing pusher 5 is given a clicking sensation (click feeling) along with the elastic deformation of elastically deformable portion 30. When elastically deformable portion 30 is deformed as described above, movable electrode 8 comes into contact with fixed electrode 7, and first terminal 11 and second terminal 12 are electrically connected to each other as shown in FIG. 2. Hence, input device 1 enters the second state.

In order to change input device 1 from the second state to the first state, the operator only needs to stop pressing pusher 5. When pusher 5 is no longer pressed, elastically deformable portion 30 returns to its original shape by its restoring force. Then, when elastically deformable portion 30 returns to the original shape, movable electrode 8 is separated from fixed electrode 7 as shown in FIG. 1A, so that first terminal 11 and second terminal 12 are not electrically connected to each other. Hence, input device 1 enters the first state.

### 1.1.4 Test

When input device 1 is switched between the first state and the second state, support portion 31 slides on mounting surface S10 (supporting electrode 921 in present exemplary embodiment) due to elastic deformation of elastically deformable portion 30 of movable member 3. When support portion 31 slides on mounting surface S10, mounting surface S10 is slightly scraped by support portion 31, and scrape dust 500 (see FIG. 12) is generated. When the number of times of switching between the first state and the second state of input device 1 increases, as shown in FIG. 12, recess 400 may eventually be formed in mounting surface S10, and scrape dust 500 may accumulate in recess 400. Scrape dust 500 is generally a metal oxide and has electrical insulation. Hence, when a large amount of scrape dust 500 accumulates in recess 400, the electrical characteristics of support portion 31 and supporting electrode 921 may deteriorate. This leads to a decrease in reliability of input device 1.

In input device 1, movable member 3 is in contact with mounting surface S10 at protruding curved surface 310 of support portion 31. Hence, generation of scrape dust 500 caused by sliding of movable member 3 on mounting surface S10 can be reduced. Further, since support portion 31 has protruding curved surface 310, scrape dust 500 can be brushed off, and accumulation of scrape dust 500 between protruding curved surface 310 and mounting surface S10 (in recess 400 of mounting surface S10) can be curbed. Accordingly, it is possible to curb a decrease in reliability (particularly long-term reliability) due to generation of scrape dust 500. Hence, according to input device 1, reliability can be improved.

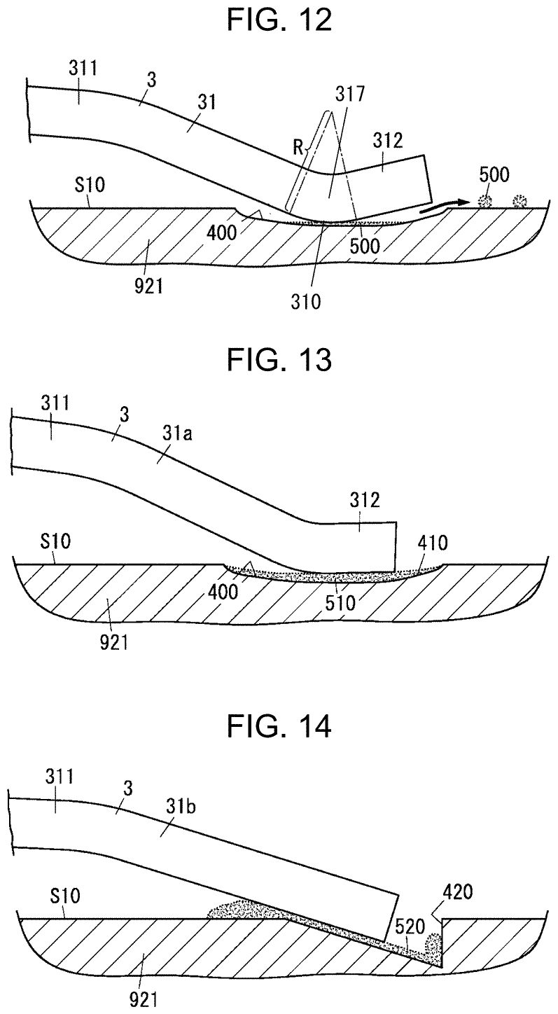

In order to confirm the advantage of such input device 1, a test was performed using Comparative Example 1 (see FIG. 13) and Comparative Example 2 (see FIG. 14).

As shown in FIG. 13, Comparative Example 1 is an input device having support portion 31a different from support portion 31 of input device 1. Similar to support portion 31, support portion 31a has leg portion 311, but instead of extension portion 312 shown in FIG. 12, support portion 31a has extension portion 312 (see FIG. 13) extending along mounting surface S10 from the tip end of leg portion 311. As shown in FIG. 13, support portion 31a is in contact with mounting surface S10 at a flat surface which is one surface of extension portion 312.

As shown in FIG. 14, Comparative Example 2 is an input device having support portion 31b different from support portion 31 of input device 1. Similar to support portion 31, support portion 31b has leg portion 311 but does not have extension portion 312. As shown in FIG. 14, support portion 31b is in contact with mounting surface S10 at a corner of the tip end of leg portion 311.

In the test, switching between the first state and the second state of the input device (pressing operation of pusher 5) was repeated a predetermined number of times. Then, as a test result, the state of mounting surface S10 was observed to evaluate input device 1, Comparative Example 1, and Comparative Example 2.

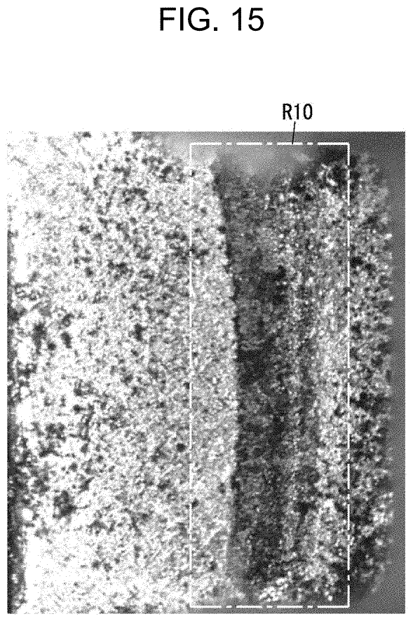

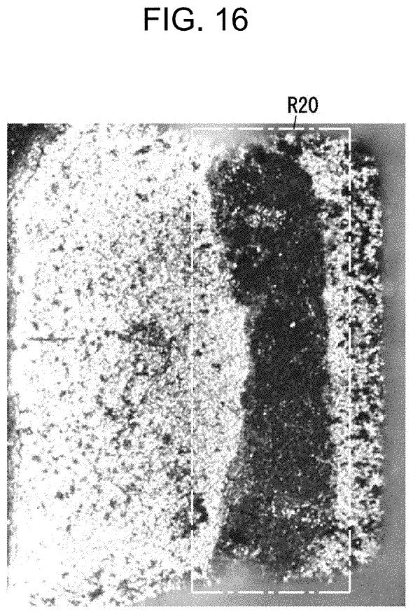

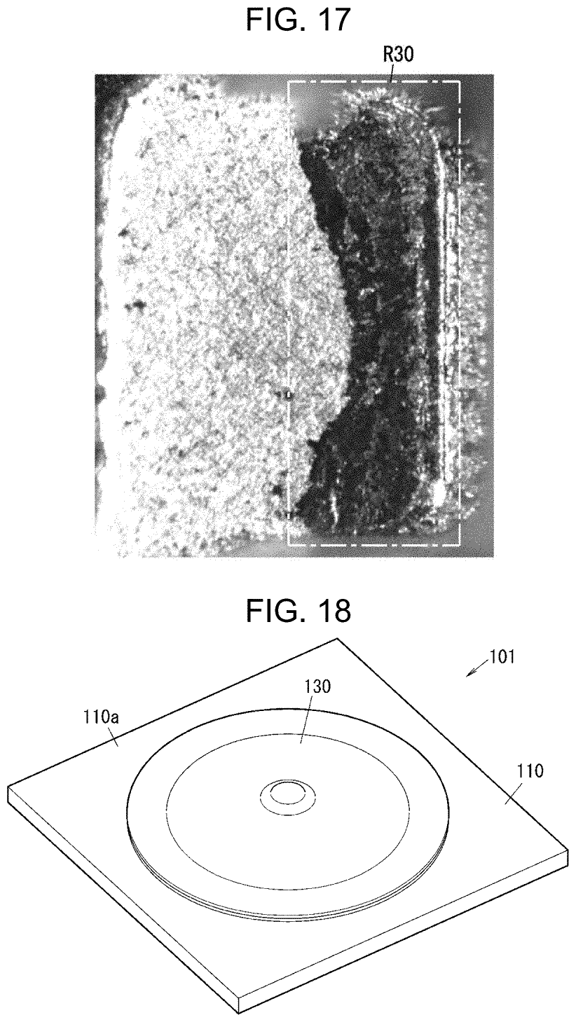

FIG. 15 is an image showing a state of mounting surface S10 of input device 1 of the aforementioned exemplary embodiment after the test. In FIG. 15, R10 is a region including a trace formed by support portion 31 sliding on mounting surface S10. FIG. 16 is an image showing a state of mounting surface S10 of the input device of Comparative Example 1 after the test. In FIG. 16, R20 is a region including a trace formed by support portion 31a sliding on mounting surface S10. FIG. 17 is an image showing a state of mounting surface S10 of the input device of Comparative Example 2 after the test. In FIG. 17, R30 is a region including a trace formed by support portion 31b sliding on mounting surface S10. In the images of FIGS. 15 to 17, the darker the color, the larger the amount of scrape dust.

As is apparent from the comparison of the images in FIGS. 15 to 17, in input device 1, the amount of scrape dust is obviously smaller than those in Comparative Example 1 and Comparative Example 2. This is considered to be because generation of scrape dust 500 is reduced by the contact between protruding curved surface 310 of support portion 31 and mounting surface S10, and further, because support portion 31 brushes off scrape dust 500 to the outside from recess 400 with protruding curved surface 310.

On the other hand, in Comparative Example 1, as shown in FIG. 13, support portion 31a is in contact with mounting surface S10 at a flat surface which is one surface of extension portion 312. Hence, it is considered that scrape dust 510 is not brushed off much from recess 410 formed by scraping mounting surface S10, and scrape dust 510 is accumulated in recess 410. Accordingly, as compared with Comparative Example 1, input device 1 can reduce the amount of scrape dust accumulated between the support portion and the mounting surface, and improvement in reliability can be expected.

Additionally, in Comparative Example 2, as shown in FIG. 14, support portion 31b is in contact with mounting surface S10 at the corner of the tip end of leg portion 311. Hence, it is considered that recess 420 formed by scraping mounting surface S10 is deeper than the case of input device 1 and Comparative Example 1, and scrape dust 520 accumulates easily. Accordingly, as compared with Comparative Example 2, input device 1 can reduce the amount of scrape dust accumulated between the support portion and the mounting surface, and improvement in reliability can be expected.

### 1.2 Second Exemplary Embodiment

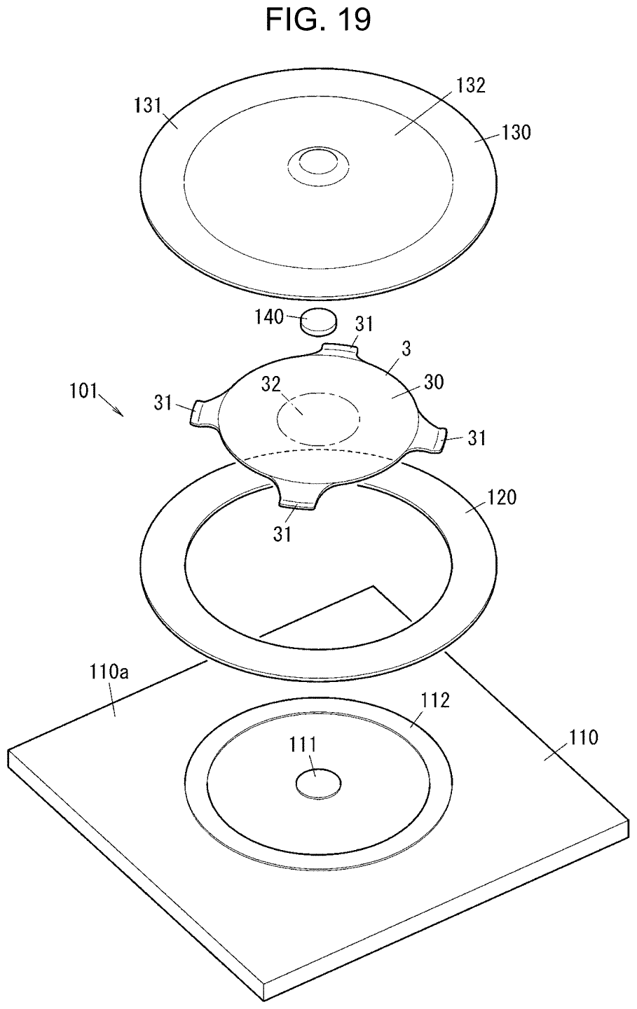

FIG. 18 shows input device 101 according to a second exemplary embodiment. Input device 101 is a push switch similar to input device 1. As shown in FIG. 19, input device 101 includes base 110, movable member 3, spacer 120, cover 130, and pusher 140. Movable member 3 has the same configuration as that of the first exemplary embodiment.

Base 110 includes a substrate (wiring board, printed circuit board). As shown in FIGS. 18 and 19, base 110 has a flat quadrangular (e.g., square) plate shape. One surface (upper surface in FIGS. 18 and 19) of base 110 in the thickness direction forms mounting surface 110a for mounting movable member 3. Additionally, electrode (fixed electrode) 111 and electrode (supporting electrode) 112 are provided on mounting surface 110a. Fixed electrode 111 has a circular shape in plan view. Supporting electrode 112 has an annular shape in plan view. Fixed electrode 111 is inside supporting electrode 112. Additionally, fixed electrode 111 and supporting electrode 112 are concentric. Fixed electrode 111 and supporting electrode 112 can be provided by a conventionally known technique such as an additive process (full additive process, semi-additive process) or a subtractive process.

Similar to the first exemplary embodiment, movable member 3 is mounted on mounting surface 110a at protruding curved surface 310 (see FIG.

1B) such that movable electrode 8 faces fixed electrode 111. In particular, support portion 31 of movable member 3 is positioned on supporting electrode 112. That is, support portion 31 is in contact with supporting electrode 112 at protruding curved surface 310.

Spacer 120 is provided between base 110 and cover 130 to form a space for accommodating movable member 3. Spacer 120 has a film shape. Spacer 120 has an annular shape in plan view. Spacer 120 has an inner diameter larger than an outer diameter of supporting electrode 112. Spacer 120 is disposed on mounting surface 110a of base 110 so as to surround fixed electrode 111 and supporting electrode 112. Note that spacer 120 has electrical insulation. As one example, spacer 120 is made of synthetic resin.

Cover 130 is attached to base 110 so as to cover movable member 3. In the present exemplary embodiment, cover 130 is attached to base 110 with spacer 120 interposed therebetween. Cover 130 has a film shape. Cover 130 is circular in plan view. Cover 130 has annular fixing portion 131 attached to spacer 120 and dome portion 132 located inside fixing portion 131 and covering movable member 3. Cover 130 has electrical insulation. Additionally, cover 130 has flexibility, so that pressure receiving portion 32 is easily pressed through cover 130. As one example, cover 130 is a film made of synthetic resin (e.g., polyethylene terephthalate). The material of cover 130 is not limited to synthetic resin (e.g., polyethylene terephthalate), and may be an elastic material (rubber or the like).

Pusher 140 is a member for pressing pressure receiving portion 32 of elastically deformable portion 30 of movable member 3. More specifically, pusher 140 is a member for efficiently transmitting the force applied to cover 130 to pressure receiving portion 32. Pusher 140 has electrical insulation. As one example, pusher 140 can be formed by punching a synthetic resin (e.g., polyethylene terephthalate) film. The material of pusher 140 is not limited to synthetic resin (e.g., polyethylene terephthalate), and may be an elastic material (rubber or the like). Pusher 140 has a solid columnar shape. Pusher 140 is disposed on the opposite side of fixed electrode 111 with respect to movable member 3, so that pusher 140 faces pressure receiving portion 32 of movable member 3. In the present exemplary embodiment, pusher 140 is interposed between movable member 3 and cover 130 while being in contact with both members.

Hereinafter, an operation of input device 101 will be described. Input device 101 has a first state and a second state. In the first state, elastically deformable portion 30 of movable member 3 is not elastically deformed, and movable electrode 8 is not in contact with fixed electrode 111. In the second state, elastically deformable portion 30 of movable member 3 is elastically deformed, and movable electrode 8 is in contact with fixed electrode 111.

In order to change input device 1 from the first state to the second state, the operator only needs to press pusher 140 with a certain force or more through cover 130. As a result, pressure receiving portion 32 of movable member 3 is pressed toward mounting surface S10 through pusher 140. As a result, elastically deformable portion 30 of movable member 3 is gradually deformed. Then, when the magnitude of the force pressing elastically deformable portion 30 exceeds a certain value, elastically deformable portion 30 is vigorously buckled and greatly deformed. With such a flipping operation of elastically deformable portion 30, the operator pressing pusher 140 is given a clicking sensation (click feeling) along with the elastic deformation of elastically deformable portion 30. Then, when elastically deformable portion 30 is deformed as described above, movable electrode 8 comes into contact with fixed electrode 111. Hence, input device 101 enters the second state.

In order to change input device 101 from the second state to the first state, the operator only needs to stop pressing pusher 140. When pusher 140 is no longer pressed, elastically deformable portion 30 returns to its original shape by its restoring force. Then, when elastically deformable portion 30 returns to its original shape, movable electrode 8 is separated from fixed electrode 111. Hence, input device 101 enters the first state.

In input device 101, movable member 3 is in contact with mounting surface 110a at protruding curved surface 310 of support portion 31. Hence, generation of scrape dust caused by sliding of movable member 3 on mounting surface 110a can be reduced. Further, since support portion 31 has protruding curved surface 310, scrape dust can be brushed off, and accumulation of scrape dust between protruding curved surface 310 and mounting surface 110a can be curbed. Accordingly, it is possible to curb a decrease in reliability (particularly long-term reliability) due to generation of scrape dust. As described above, according to movable member 3 and input device 101, reliability can be improved.

### 2. Modification

The exemplary embodiment of the present disclosure is not limited to the above exemplary embodiments. The above exemplary embodiments can be variously changed according to design and the like as long as the object of the present disclosure can be achieved. Modifications of the above exemplary embodiments will be listed below.

For example, the shape of movable member 3 is not limited to the shape described in the above exemplary embodiments.

### 2.1 Modification 1

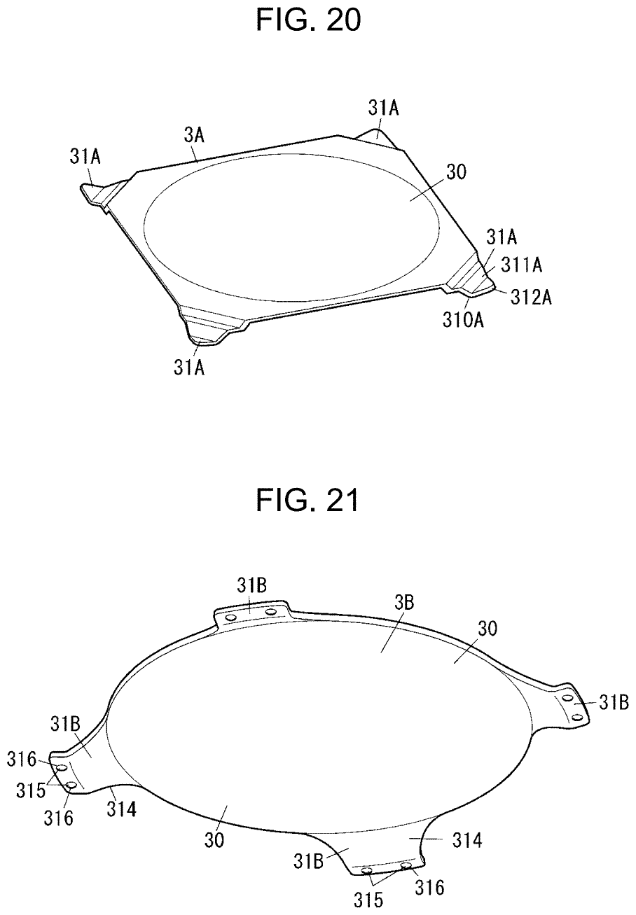

FIG. 20 illustrates movable member 3A of an input device according to Modification 1. Movable member 3A has a quadrangular (e.g., square) plate shape as a whole. Movable member 3A has dome-shaped elastically deformable portion 30 at a central portion thereof. Additionally, movable member 3A has support portions 31A at four corners thereof. Each support portion 31A has leg portion 311A and an extension portion 312A. Leg portion 311A extends from the peripheral edge of elastically deformable portion 30 toward mounting surface S10. Extension portion 312A extends from the tip end of leg portion 311A in a direction separating from mounting surface S10.

That is, support portion 31A has an L shape in side view. In support portion 31A, a boundary portion between leg portion 311A (surface of leg portion 311A on mounting surface S10 side) and extension portion 312A (surface of extension portion 312A on mounting surface S10 side) is protruding curved surface 310A. Support portion 31A is in contact with mounting surface S10 at protruding curved surface 310A.

In the above-described Modification 1, similar to input devices 1, 101 of the first and second exemplary embodiments, movable member 3A is in contact with mounting surface S10 at protruding curved surface 310A of support portion 31A. Hence, the reliability can be improved by the input device of Modification 1 as well.

### 2.2 Modification 2

FIG. 21 illustrates movable member 3B of an input device according to Modification 2. Movable member 3B has support portion 31B different from support portion 31 of movable member 3.

More specifically, similar to movable member 3, movable member 3B has a circular plate shape as a whole. Movable member 3B has elastically deformable portion 30 and multiple (four in FIG. 21) support portions 31B. Movable member 3b is made of the same material as movable member 3.

Each of support portions 31B has leg portion 314 and multiple (two in FIG. 21) protrusions 315. Leg portion 314 extends from the peripheral edge of elastically deformable portion 30 toward mounting surface S10. Leg portion 314 has a plate shape, and has a width narrowing toward the tip end. Additionally, the tip end of leg portion 314 is bent. Each protrusion 315 protrudes from the tip end of leg portion 314 toward mounting surface S10. Each protrusion 315 has a hemispherical shape. Hence, the surface of protrusion 315 includes protruding curved surface 316. Two protrusions 315 are arranged in the width direction of leg portion 314.

Support portion 31B (leg portion 314 and protrusion 315) is formed by bending a tip end portion of a metal plate to be leg portion 314 of support portion 31B and performing embossing on a part of leg portion 314. Accordingly, protruding curved surface 316 is formed by the embossing for forming protrusion 315. Note that the radius of curvature of protruding curved surface 316 may be set under the same condition as radius of curvature R of protruding curved surface 310.

In the above-described Modification 2, similar to input device 1, 101 of the first and second exemplary embodiments, movable member 3B is in contact with mounting surface S10 at protruding curved surface 316 of support portion 31B. Hence, the reliability can be improved by the input device of Modification 2 as well.

Note that in Modification 2, the number of protrusions 315 is not limited, and the shape of protrusion 315 is not limited as long as its surface includes protruding curved surface 316. Additionally, protrusion 315 may be located in a middle portion of leg portion 314 instead of the tip end thereof. That is, the position of protrusion 315 in leg portion 314 is not particularly limited.

### 2.3 Other modifications

Elastically deformable portion 30 of movable member 3 may be made of resin instead of metal. Additionally, elastically deformable portion 30 is not limited to a dome shape, and may have any shape capable of elastically deforming. Note that elastically deformable portion 30 may have a shape that generates a click feeling, but is not limited thereto.

The shape and the like of support portion 31 are not limited to the above exemplary embodiments, and can be changed. As one example, leg portion 311 may be bent at one or more positions in the width direction of leg portion 311 such that intermediate portion 311b protrudes more than both end portions 311a. Similarly, extension portion 312 may be bent at one or more positions in the width direction of extension portion 312 such that intermediate portion 312b protrudes more than both end portions 312a. As one example, intermediate portion 311b of leg portion 311 does not necessarily have to protrude most at the center, and may protrude most at a portion closer to one of both end portions 311a than the other. Similarly, intermediate portion 312b of extension portion 312 does not necessarily have to protrude most at the center, and may protrude most at a portion closer to one of both end portions 312a than the other.

Additionally, the radius of curvature of the surface of leg portion 311 in a cross section orthogonal to the protruding direction of leg portion 311 dos not necessarily have to be equal to the radius of curvature of the surface of extension portion 312 in a cross section orthogonal to the protruding direction of extension portion 312. Additionally, protruding curved surface 310 does not necessarily have to be flat and may have an arc shape in a cross section along the width of the boundary portion. Additionally, the boundary portion may extend in an elliptical arc shape in plan view. That is, the boundary portion may extend in a curved shape instead of a linear shape in plan view.

The number of support portions 31 of movable member 3 is not limited either. For example, movable member 3 may have three support portions 31, and three support portions 31 may be arranged at equal intervals so as to surround elastically deformable portion 30. Further, in a case where movable member 3 has one support portion 31, support portion 31 may have an annular shape surrounding elastically deformable portion 30.

The number of movable members 3 is not particularly limited, and multiple movable members 3 may be used in an overlapping manner. In this case, depending on the number of movable members 3 to be overlapped, the magnitude of the operation force required for movable member 3 to buckle changes, and the operation feeling of input device 1 changes.

The shapes of case 2, pusher 5, holder 6, first conductive member 91, and second conductive member 92 are not limited to the shapes shown in the above exemplary embodiments.

In one modification, case 2 may have a circular shape or a polygonal shape other than a quadrangle in plan view.

In one modification, pusher 5 does not necessarily have to protrude from case 2. For example, pusher 5 may be accommodated in case 2. In this case, a portion of cover 22 of case 2 covering pusher 5 may have flexibility. In this case, pusher 5 may have conductivity, and may be made of metal, for example.

In one modification, there does not necessarily have to be a gap between pusher 5 and movable member 3 in the first state. That is, in the first state, pusher 5 may be in contact with pressure receiving portion 32 of movable member 3.

In one modification, holder 6 does not necessarily have to be made of rubber. Holder 6 only needs to have conductivity, and may be made of metal, for example.

In one modification, pusher 5 and holder 6 do not necessarily have to be integrated, and may be separate bodies. In this case, holder 6 only needs to be fixed to pusher 5 by appropriate fixing means such as adhesion.

Additionally, pusher 5 and holder 6 are not essential.

In one modification, the numbers of first conductive member 91 and second conductive member 92 are not particularly limited either. Additionally, in second conductive member 92, supporting electrode 921 may include two or more electrodes, and for example, multiple supporting electrodes 921 corresponding to multiple support portions 31 of movable member 3 may be provided.

In the above exemplary embodiments, fixed electrode 7 and movable electrode 8 form a mechanical contact. In one modification, there may be a dielectric layer between fixed electrode 7 and movable electrode 8, in which case a pressure sensor is formed. That is, movable electrode 8 and fixed electrode 7 can be used for a mechanical contact or a pressure sensor.

The stroke length of input device 1, that is, the movement amount of pusher 5 from the first state to the second state of input device 1 by the pressing operation can be set appropriately. For example, input device 1 may be a short stroke type having a relatively short stroke length, a long stroke type having a relatively long stroke length, or a middle stroke type corresponding a type between the short stroke type and the long stroke type. Additionally, input device 1 is not limited to the normally open type, and may be a normally closed type that is turned off only at the time of operation. That is, pusher 5 of input device 1 may be configured to press movable member 3 from the OFF position to the ON position by receiving a force from the outside, or vice versa.

Input device 1 is not limited to the configuration used in an operation unit of a device to be operated by a person, and may be used in a detection unit or the like of a device, for example. In the case where input device 1 is used as a detection unit of a device, input device 1 is used as a limit switch to detect a position of a mechanical component such as an actuator, for example.

### 3. Aspects

One aspect of a movable member of the present disclosure includes: elastically deformable portion 30 that curves upward in a protruding manner and includes movable electrode 8; and support portion 31 including leg portion 311 extending downward from a peripheral edge of elastically deformable portion 30, extension portion 312 extending upward from leg portion 311, and connecting portion 317 connecting leg portion 311 and extension portion 312. Leg portion 311 has intermediate portion 311b positioned between both end portions 311a of leg portion 311 in a width direction of leg portion 311, intermediate portion 311b protruding, a boundary between leg portion 311 and extension portion 312 has an arc shape in top view, and a lower surface of connecting portion 317 is protruding curved surface 310 protruding downward.

In another aspect of the movable member of the present disclosure, elastically deformable portion 30 is pressed downward to be deformed to move movable electrode 8 downward.

In another aspect of the movable member of the present disclosure, leg portion 311 is curved to cause intermediate portion 311b positioned between both end portions 311a in the width direction of leg portion 311.

In another aspect of the movable member of the present disclosure, extension portion 312 has intermediate portion 312b positioned between both end portions 312a in a width direction of extension portion 312, extension portion 312 protruding.

In another aspect of the movable member of the present disclosure, extension portion 312 is curved to cause intermediate portion 312b of extension portion 312 positioned between both end portions 312a in the width direction of extension portion 312 protrude.

In another aspect of the movable member of the present disclosure, intermediate portion 311b of leg portion 311 and intermediate portion 311b of extension portion 312 protrude in opposite directions.

In another aspect of the movable member of the present disclosure, intermediate portion 312b of extension portion 312 protrudes in a first direction (downward direction), and intermediate portion 311b of leg portion 311 protrudes in a second direction (upward direction).

In another aspect of the movable member of the present disclosure, intermediate portion 311b of leg portion 311 protrudes most at the center of both end portions 311a of leg portion 311.

In another aspect of the movable member of the present disclosure, intermediate portion 312b of extension portion 312 protrudes most at the center of both end portions 312a of extension portion 312.

In another aspect of the movable member of the present disclosure, intermediate portion 311b of leg portion 311 protrudes most at the center.

In another aspect of the movable member of the present disclosure, the lower end of the lower surface (protruding curved surface 310) of connecting portion 317 is an arc-shaped line having a constant height position.

In another aspect of the movable member of the present disclosure, a boundary between leg portion 311 and extension portion 312 has an arc shape of a perfect circle in top view.

In another aspect of the movable member of the present disclosure, a boundary between leg portion 311 and extension portion 312 has an arc shape centered on movable electrode 8 in top view.

In another aspect of the movable member of the present disclosure, the outer periphery of elastically deformable portion 30 is a circle centered on movable electrode 8 in top view.

According to the above-described aspects, reliability can be improved.

In another aspect of the movable member of the present disclosure, elastically deformable portion 30 has a dome shape, and a central portion of elastically deformable portion 30 is movable electrode 8. According to this aspect, the movable member gives a click feeling.

Another aspect of the movable member of the present disclosure has conductivity. According to this aspect, reliability can be improved.

In another aspect of the movable member of the present disclosure, protruding curved surface 310 is formed by bending for forming extension portion 312. According to this aspect, movable member 3 can be manufactured easily.

Another aspect of the movable member of the present disclosure includes multiple support portions 31. According to this aspect, movable member 3 can be disposed stably.

In another aspect of the movable member of the present disclosure, multiple support portions 31 extend radially from movable electrode 8 in top view. According to this aspect, movable member 3 can be disposed more stably.

One aspect of the input device of the present disclosure includes: fixed electrode 7; base 21 (110) having mounting surface S10 (110a) on which fixed electrode 7 is provided; and movable member 3 of the present disclosure. Movable member 3 is mounted on mounting surface S10 (110a), movable electrode 8 facing fixed electrode 7, and protruding curved surface 310 of movable member 3 is in contact with mounting surface S10 (110a). According to this aspect, reliability can be improved.

### REFERENCE MARKS IN THE DRAWINGS

1, 101 input device
11 first terminal
12 second terminal
21, 110 base
3, 3A, 3B movable member
30 elastically deformable portion
31, 31A, 31B support portion
310, 310A protruding curved surface
311, 311A leg portion
311a end portion
311b intermediate portion
312, 312A extension portion
312a end portion
312b intermediate portion
313 curve
314 leg portion
315 protrusion
316 protruding curved surface
317 connecting portion
7, 111 fixed electrode
8 movable electrode
81 first surface
82 second surface
921, 112 supporting electrode
S10, 110a mounting surface

1. A movable member comprising:
an elastically deformable portion that curves upward in a protruding manner and includes a movable electrode; and
a support portion having a leg portion extending downward from a peripheral edge of the elastically deformable portion, an extension portion extending upward from the leg portion, and a connecting portion connecting the leg portion and the extension portion,
wherein
the leg portion has an intermediate portion positioned between both end portions in a width direction of the leg portion, the intermediate portion protruding,
a boundary between the leg portion and the extension portion has an arc shape in top view, and
a lower surface of the connecting portion is a protruding curved surface protruding downward.

2. The movable member according to claim 1, wherein the elastically deformable portion is pressed downward to be deformed to move the movable electrode downward.

3. The movable member according to claim 1, wherein the leg portion is curved to cause the intermediate portion positioned between both the end portions in the width direction of the leg portion protrude.

4. The movable member according to any one of claim 1, wherein the extension portion has an intermediate portion positioned between both end portions in a width direction of the extension portion, the extension portion protruding.

5. The movable member according to claim 4, wherein the extension portion is curved to cause the intermediate portion of the extension portion positioned between both the end portions in the width direction of the extension portion protrude.

6. The movable member according to claim 4, wherein the intermediate portion of the leg portion and the intermediate portion of the extension portion protrude in opposite directions.

7. The movable member according to claim 6, wherein
the intermediate portion of the extension portion protrudes in a first direction, and
the intermediate portion of the leg portion protrudes in a second direction opposite to the first direction.

8. The movable member according to claim 1, wherein the intermediate portion of the leg portion protrudes most at a center of both the end portions of the leg portion.

9. The movable member according to claim 4, wherein the intermediate portion of the extension portion protrudes most at a center of both the end portions of the extension portion.

10. The movable member according to claim 9, wherein the intermediate portion of the leg portion protrudes most at the center.

11. The movable member according to claim 1, wherein a lower end of the lower surface of the connecting portion is an arc-shaped line having a constant height position.

12. The movable member according to claim 1, wherein the boundary between the leg portion and the extension portion has an arc shape of a perfect circle in top view.

13. The movable member according to claim 1, wherein the boundary between the leg portion and the extension portion has an arc shape centered on the movable electrode in top view.

14. The movable member according to claim 13, wherein an outer periphery of the elastically deformable portion is a circle centered on the movable electrode in top view.

15. The movable member according to claim 1, wherein
the elastically deformable portion has a dome shape, and
a central portion of the elastically deformable portion is the movable electrode.

16. The movable member according to claim 1, wherein the movable member has conductivity.

17. The movable member according to claim 1, wherein the protruding curved surface is formed by bending for forming the extension portion.

18. The movable member according to claim 1, wherein
the movable member includes a plurality of support portions, and
each of the plurality of support portions is the support portion.

19. The movable member according to claim 18, wherein the plurality of support portions extend radially from the movable electrode in top view.

20. An input device comprising:
a fixed electrode;
a base having a mounting surface on which the fixed electrode is provided; and
the movable member according to claim 1,
wherein
the movable member is mounted on the mounting surface, the movable electrode facing the fixed electrode, and
the protruding curved surface of the movable member is in contact with the mounting surface.
